(19) United States
(12) Patent Application Publication
(10) Pub. No.: US 2009/0208392 A1
(43) Pub. Date: Aug. 20, 2009

(54) PROCESS FOR PRODUCING ALPHA-HEMIHYDRATE GYPSUM

(75) Inventor: Donald F. Klus, Tigard, OR (US)

Correspondence Address: PATENT GROUP GA030-43;Georgia-Pacific LLC, 133 PEACHTREE STREET, N.E., ATLANTA, GA, 30303-1847, US

(73) Assignee: GEORGIA-PACIFIC GYPSUM, LLC, Atlanta, GA (US)

(21) Appl. No.: 12/031,174

(22) Filed: Feb. 14, 2008

(51) Int. Cl. C04B 11/02; C04B 28/14; C04B 11/028

(52) U.S. Cl. 423/171; 106/783; 423/172; 423/555; 432/91

(57) ABSTRACT

A process for producing alpha-hemihydrate gypsum from dihydrate gypsum includes feeding a slurry comprising the dihydrate gypsum and water into a heating tube, heating the heating tube at a temperature effective to generate steam and pressure from the water, wherein the steam and pressure are effective to convert the dihydrate gypsum to the alpha-hemihydrate gypsum, and withdrawing the alpha-hemihydrate gypsum from the heating tube.

### BACKGROUND OF THE INVENTION

The present disclosure generally relates to a process for producing alpha-hemihydrate gypsum from dihydrate gypsum, and more particularly, to a process for continuously producing alpha-hemihydrate gypsum at high pressure.

Calcium sulfate hemihydrate occurs in two forms, alpha type (also known as calcium sulfate alpha-hemihydrate, alpha-hemihydrate gypsum, or simply alpha gypsum) and beta type (also known as calcium sulfate beta-hemihydrate, beta-hemihydrate gypsum, or beta gypsum). Alpha-hemihydrate gypsum is generally characterized by needle-shaped crystals which have a lower water requirement, set faster (i.e., produce calcium sulfate dihydrate faster), and produce articles of higher strength. The formation of alpha-hemihydrate gypsum from calcium sulfate dihydrate can be confirmed by scanning electron micrographs (SEM), differential scanning calorimetry (DSC), and the like.

Alpha gypsum is used in many applications for its desirable physical properties such as fire resistance, thermal and hydrometric dimensional stability, compressive strength, neutral pH, and the like. Various methods are known for producing alpha-hemihydrate gypsum of varying quality from calcium sulfate dihydrate (i.e., dihydrate gypsum). Calcium sulfate beta-hemihydrate can also be converted to alpha-hemihydrate gypsum by first forming calcium sulfate dihydrate.

One process of forming alpha-hemihydrate gypsum involves placing calcium sulfate dihydrate in an autoclave in the presence of saturated steam at elevated pressure over an extended period of time. This method can be used for autoclaving of lump or ground gypsum. Typical pressures for the autoclave can be from atmospheric to about 15 psi. The formation of the alpha gypsum in the autoclave can take from about 1 hour to about 5 hours, depending on the form of gypsum used. In another process, gypsum is added to an aqueous solution, including a crystallization accelerator, and heated over an extended period of time under increased pressure while keeping the gypsum slurry in an agitated state. This method can take anywhere from about 6 hours to about 16 hours.

In still another process, gypsum is suspended in an aqueous solution, at atmospheric pressure, containing a soluble inorganic salt such as magnesium sulfate, sodium chloride, or calcium chloride, an inorganic acid such as sulfuric acid, nitric acid, or phosphoric acid, or an alkali metal salt of an organic acid, and heated at a temperature between about 80 degrees Celsius (° C.) and the boiling point of the solution. This process can require residence times of about 1 hour to about 3 hours.

All of these methods are typically batch operations wherein the resultant product is filtered from the solution, washed with hot water to remove the inorganic salt, acid, or other catalyst from the surface of the crystals, and then heated to dry surface moisture from the crystals. The time-limiting step in these processes is the step of forming the alpha-hemihydrate gypsum. Even in processes where the dihydrate gypsum slurry is continuously fed into a vessel and alpha-hemihydrate gypsum continuously removed from the vessel, the slurry must remain in the vessel for a residence time on the order of hours, as described above, for the full conversion to alpha-hemihydrate gypsum.

Accordingly, there remains a need for an improved process for producing alpha-hemihydrate gypsum.

### BRIEF DESCRIPTION OF THE INVENTION

Disclosed herein are processes for continuously producing alpha-hemihydrate gypsum. In one embodiment, the process comprises feeding a slurry comprising the dihydrate gypsum and water into a heating tube, heating the heating tube at a temperature effective to generate steam and pressure from the water, wherein the steam and pressure are effective to convert the dihydrate gypsum to the alpha-hemihydrate gypsum, and withdrawing the alpha-hemihydrate gypsum from the heating tube.

In another embodiment, the process comprises mixing the dihydrate gypsum with water to form a slurry, pumping the slurry into a heating tube at a flowrate effective for the slurry to have an average residence time in the heating tube of less than or equal to about 10 minutes, heating the heating tube at a temperature effective to generate steam and pressure from the water, wherein the steam and pressure are effective to substantially convert the dihydrate gypsum to the alpha-hemihydrate gypsum, and withdrawing the alpha-hemihydrate gypsum and steam from the heating tube, cooling the alpha-hemihydrate gypsum and steam to a temperature effective to condense the steam, and removing the water from the alpha-hemihydrate gypsum.

In another embodiment, a system for converting producing alpha-hemihydrate gypsum from dihydrate gypsum comprises a mixer configured to mix a first amount of dihydrate gypsum with a second amount of water to form a slurry, a heating tube in fluid communication with the mixer, wherein the heating tube has a coiled shape with an inlet and an outlet, wherein the inlet is configured to receive the slurry from the mixer, a heat source in operative communication with the heating tube, wherein the heat source is configured to heat the heating tube to a temperature effective to generate steam and pressure from the water, wherein the steam and pressure are effective to substantially convert the dihydrate gypsum to the alpha-hemihydrate gypsum, a steam condenser in fluid communication with the outlet of the heating tube, wherein the steam condenser comprises a cooling water stream and is configured to cool the alpha-hemihydrate gypsum and steam to a temperature effective to condense the steam, a water removal unit in fluid communication with the steam condenser, wherein the water removal unit comprises a suction belt and a vacuum suction unit disposed below the suction belt, wherein the water removal unit is configured to remove the water from the alpha-hemihydrate gypsum, and a drying section in fluid communication with the water removal unit, wherein the drying section comprises a drying apparatus configured to dry the alpha-hemihydrate gypsum.

The above described and other features are exemplified by the following figures and detailed description.

### BRIEF DESCRIPTION OF THE DRAWINGS

Referring now to the figures wherein the like elements are numbered alike:

FIG. 1 is a cross-sectional view of an exemplary embodiment of a heating tube for converting dihydrate gypsum to alpha hemihydrate;

FIG. 2 is a top down view of an exemplary embodiment of the heating tube of FIG. 1; and

FIG. 3 is a schematic of an exemplary embodiment of a system for producing alpha-hemihydrate gypsum

### DETAILED DESCRIPTION OF THE INVENTION

Disclosed herein are processes for continuously producing alpha-hemihydrate gypsum. In one embodiment, a process for continuously producing alpha-hemihydrate gypsum from dihydrate gypsum includes feeding a slurry comprising the dihydrate gypsum and water into a heating tube. The heating tube can be heated to a temperature effective to generate steam and pressure from the water, wherein the steam and pressure are effective to convert the dihydrate gypsum to the alpha-hemihydrate gypsum. The alpha gypsum can then be withdrawn from the heating tube.

Fast, continuous conversion of dihydrate gypsum to alpha gypsum hemihydrate is desirable. The ability to produce large quantities at a rapid rate is needed in the industry. The process as disclosed herein continuously converts dihydrate gypsum into alpha gypsum hemihydrate in the order of minutes, rather than hours. As used herein, the term “continuously” or “continuous process” is generally intended to mean a non-batch type process that can be “continuously” run to produce the alpha gypsum hemihydrate. Typically, current conversion processes can use large vessels, wherein ground gypsum or a gypsum slurry fills the vessel and is heated and/or pressurized to convert the gypsum. The reason for the inordinately long time to convert gypsum to alpha-form hemihydrate is that in order to produce the large quantities of alpha-hemihydrate gypsum desired for an application, the vessel, kettle, calciner, or the like, must be very large. Much of the time, therefore, is spent heating up and pressurizing the material in the vessel in order to facilitate the conversion to the alpha gypsum. The heat in these batch-type processes drives off about three quarters of the combined water of the gypsum slurry, and the pressure allows the gypsum crystals to form in a manner that less water is needed to make a workable slurry in rehydration. Again, to achieve these temperatures and pressures in such large vessels is costly and time consuming. The process as disclosed herein is able to heat and pressurize the slurry in minutes, instead of hours, because the heating tube exposes a maximum amount of the heated surface area directly to the slurry material.

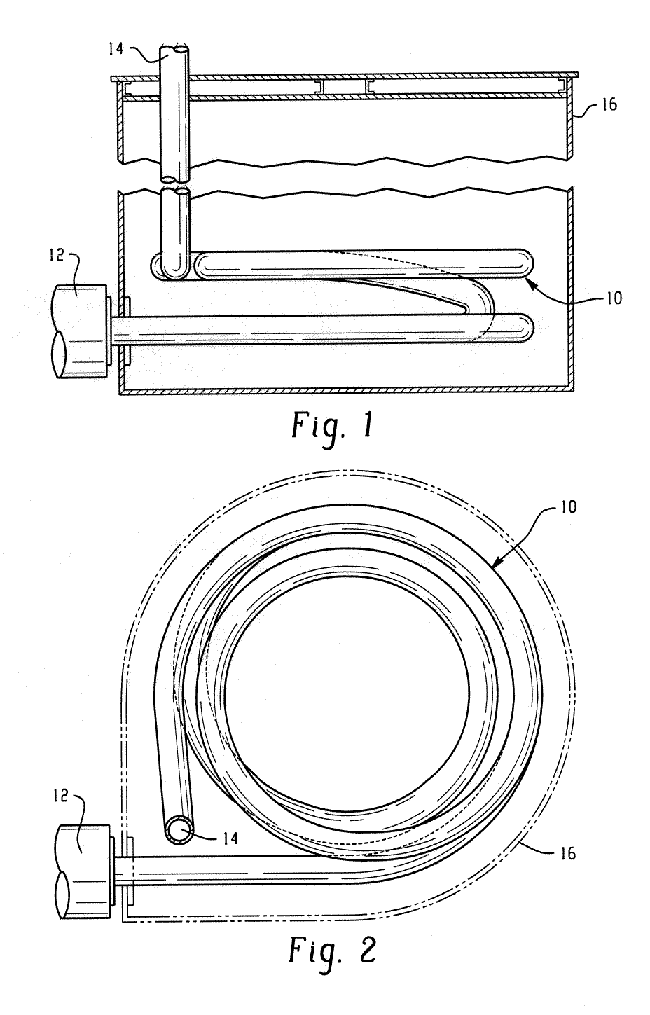

Referring now to FIG. 1, a cross-sectional view of an exemplary embodiment of a heating tube 10 for converting dihydrate gypsum to alpha hemihydrate is illustrated. The heating tube 10 can have any shape effective to permit the flow of gypsum slurry through the tube. As will be discussed in more detail below, it is the amount of surface contact between the heating tube and the slurry, as well as the pressure created within the tube, which permits the quick, efficient conversion of the slurry to alpha gypsum. It is beneficial, therefore, for the heating tube to have a shape that optimizes pressure, temperature, conversation rate, and overall output. The pressure produced inside the heating tube 10 can be controlled by the diameter of the heating tube, the amount of heat used to heat the tube and generate the steam, the slurry volume passing through the tube, and the like. Similarly, the rate of conversion from dihydrate gypsum to alpha-hemihydrate gypsum can be controlled by the temperature and pressure within the heating tube, the rate at which the slurry is passing through the tube, and the like. Even further, the output rate can be controlled by such factors as the diameter of the tube, the length of the tube, the flowrate of the slurry, and the like. The heating tube 10, therefore, can have a size and shape suitable for a desired flowrate and production capacity. A variety of internal profiles can be used, for example, square, circular, rectangular and the like, specifically substantially circular. In one embodiment, the heating tube can have an average internal diameter of about 1 centimeter (cm) to about 1 meter (m). Generally the wider the diameter of the heating tube, the longer the length. Conversely, the narrower the heating tube diameter, the shorter the length needs to be for substantial conversion of the dihydrate gypsum.

In an exemplary embodiment (as shown in FIG. 1), the heating tube has a circular coiled shape. The coiled shape is effective to permit a maximum amount of heating length in a minimum amount of space. The heating tube 10 is disposed vertically such that the slurry is fed into an inlet 12 at the bottom, circulates through the heating tube, and exits through an outlet 14 disposed above the inlet. In another embodiment, the heating tube is disposed horizontally such that the slurry circulates from left to right or right to left within the heating tube. The cross-sectional view of the heating tube in FIG. 1 merely shows two coil sections of the tube. The break in the tube is used to show that the heating tube can have longer length, including multiple coil sections, depending upon the desired process conditions as mentioned above. FIG. 2 is a top-down view of the heating tube 10 to better illustrate the coil shape of the tube.

The heating tube 10 is shown disposed inside a housing 16. The housing can be used to trap and hold heat for efficient heating of the heating tube 10. The housing can be particularly effective when an external heating source, such as an oil burner, is used to heat the heating tube 10. The housing can be effective as it can help to avoid heat loss to the environment by containing the ambient heat. The housing 16 can have any shape suitable for containing the heating tube, and will depend on the shape and size of the heating tube. In FIG. 1, the housing 16 has a cylindrical shape for containing the circularly shaped heating tube 10. While the housing 16 is shown to contain one continuous heating tube, it is to be understood that multiple heating tubes can be disposed within the housing 16. Alternatively, a process for producing alpha gypsum could include multiple housings each containing one or more heating tubes. Again, these factors will depend on desired production rates, capital cost, raw material supply, and the like.

The heating tube, as well as the housing, can comprise any material capable of withstanding the heat and pressure required to continuously convert dihydrate gypsum to alpha-hemihydrate gypsum. Also desirable is a material that will not corrode or interact with the dihydrate gypsum and water slurry. Exemplary materials for the heating tube and/or housing, therefore, can include without limitation, copper, nickel, iron, cobalt, or alloys based on the foregoing materials. Suitable alloys are typically copper-based, nickel-based, iron-based, or cobalt-based alloy, wherein the amount of copper, nickel, iron, or cobalt in the superalloy is the single greatest element by weight. Illustrative nickel-based superalloys include at least nickel (Ni), and at least one component from the group consisting of cobalt (Co), chromium (Cr), aluminum (Al), tungsten (W), molybdenum (Mo), titanium (Ti), tantalum (Ta), zirconium (Zr), niobium (Nb), rhenium (Re), carbon (C), boron (B), hafnium (Hf), and iron (Fe). Examples of iron based superalloys are designated by the trade names Haynes®, Incoloy®, Nitronic® produced by G.O. Carlson, Inc. Suitable steels include stainless steels such as American Iron and Steel Institute (AISI) steels: AISI 304 stainless steel, 310 stainless steel, AISI 347 stainless steel, AISI 405 stainless steel, AISI 410 stainless steel, Alloy 450 stainless steel, and the like.

The heating tube and housing apparatus can further comprise a heat source (not shown). The heat source can be any source capable of heating the heating tube to a temperature effective to generate steam and pressure from the water in the slurry. Exemplary heating sources can include, without limitation, open flame, electrical resistance heating, steam, hot exhaust gas, and the like. In an exemplary embodiment, the heat source can be the open flame of an oil burner. The heat source can be disposed in a location effective to impinge on the heating tube, such that the heating tube is conductively heated to a sufficient temperature by the heat source. In one embodiment, the heat source is disposed below (at the inlet end) of a vertically oriented heating tube coil.

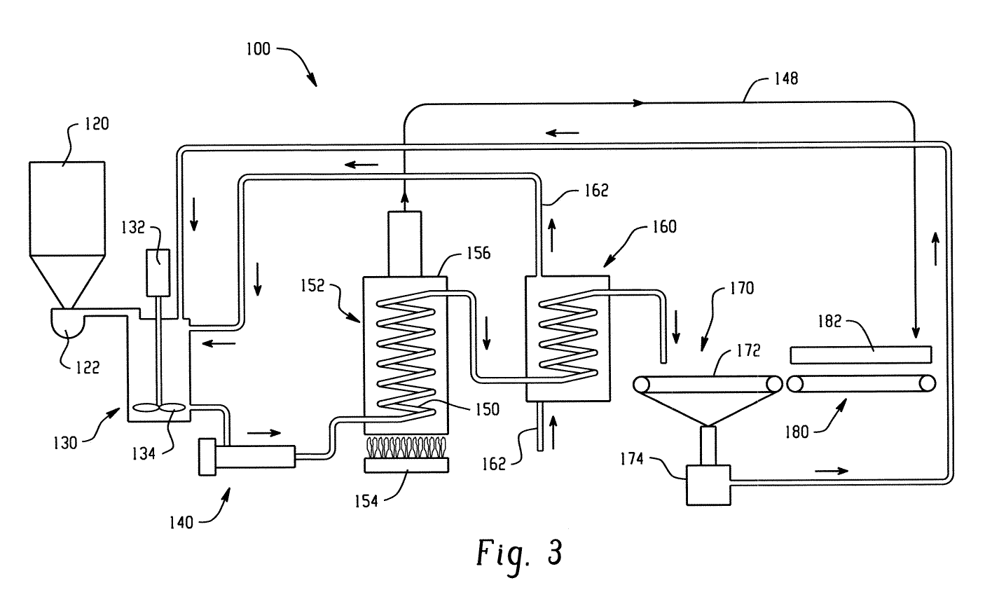

Referring now to FIG. 3, an exemplary embodiment of a system for producing alpha-hemihydrate gypsum is illustrated and designated by reference numeral 100. The system 100 includes a tank 120 provided to hold an amount of dihydrate gypsum. The tank 120 can be in operative communication with a mixer 130. Dihydrate gypsum can be fed into the mixer, via a screw feeder 122 for example. The screw feeder 122 can be disposed at the base of the tank 120 to enable gravity feeding into the screw. The mixer 130 is configured to thoroughly mix the dihydrate gypsum with water, as well as any optional ingredients, to form a slurry. The mixer can comprise paddles or blades attached to a motor via a shaft. The mixer 130 has a vertically mounted motor 132 attached to mixing paddles 134. The mixer is not only effective to blend the dihydrate gypsum with water to form a slurry, but also can be run continuously to agitate the slurry and prevent the settling of solids as the slurry is drawn from an outlet in the bottom of the mixer 130 into a slurry pump 140. The water used to make the slurry can be fresh supply water. As will be discussed in more detail below, recycle water from a multiple stages in the system can also be used as make-up water for mixing the dihydrate gypsum.

The slurry pump 140 is configured to continuously pump the gypsum slurry into the heating tube 150, which is housed in a steam generator 152. In this embodiment, the slurry enters an inlet of the heating tube at the base of the steam generator, circulates the length of the heating tube, and exits through an outlet in the heating tube at the top of the steam generator. The slurry pump can be any pump capable of moving the slurry from the mixer 130 into the heating tube 150. In an exemplary embodiment, the slurry pump 140 is a positive displacement pump. The pressure of the slurry flowing into the pump is the same as the pressure of the slurry as it exits the pump and enters the heating tube. Examples of positive displacement pumps can include internal gear pumps, external gear pumps, vane pumps, lobe pumps, and the like. The slurry pump 140 can continuously feed the slurry into the heating tube 150. The heating tube 150 can be heated by a heat source 154. In this embodiment, the heat source 154 comprises an oil burner disposed outside the heating tube, which heats the heating tube and steam generator housing 156 via an open flame. In another embodiment, the heat source can comprise multiple sources, such as multiple oil burners having multiple flames to heat various sections of a single heating tube, or to heat multiple heating tubes. The heating source 154 is configured to heat the slurry circulating through the heating tube to a temperature effective to generate steam and pressure from the water in the slurry. The steam and pressure is effective to convert the dihydrate gypsum to alpha-hemihydrate gypsum.

The converted slurry containing the alpha-hemihydrate gypsum can be continuously removed from the heating tube 150 and fed into a steam condenser 160. The steam condenser 160 can be configured to cool the converted alpha gypsum slurry, thereby condensing the steam back to water. A water stream 162 can be used to cool the slurry. In this embodiment, the cooling water stream 162 enters the bottom of the steam condenser and travels up through the condenser, exiting out the top. The cooling water stream flows counter-currently to the flow of the hot converted slurry in order to cool the slurry. The slurry can run in a conduit separated from the cooling stream, such that stream does not mix with the slurry. The cooling water stream 162 exits the top of the steam condenser at a higher temperature, having absorbed the heat from the converted slurry. In one embodiment, the cooling water stream 162 can then be recycled back to the mixer 130 for use in preparing more slurry. Use of the recycle stream can reduce waste costs, energy costs, and increase overall system efficiency.

The converted alpha gypsum slurry can then be fed to water removal and drying stages. The water removal stage can comprise any method of removing a substantial amount of water from the slurry mix, in order to leave behind the alpha-hemihydrate gypsum material. In one embodiment, a suction belt 170 can be used to remove the water. The liquid slurry can be fed onto a fine mesh belt 172. Disposed below the belt is a vacuum suction unit 174 configured to pull the water through the belt, thereby separating the water from the alpha hemihydrate. The screen can be formed of any flexible material capable of filtering the hemihydrate material from the slurry. After removal of a substantial majority of the water, the fine mesh belt 172 can advance the alpha-hemihydrate gypsum material into a drying section 180. The drying section can include a drying apparatus 182, such as air dryers, heating lamps, or other like methods of drying the remaining water in the alpha-hemihydrate gypsum. The water removed by the vacuum unit 174 can be also be recycled back to the mixer for use in preparing additional slurry. In another example of increasing process efficiency, the heat 148 generated by the heating source 154 of the steam generator 152 can be directed to the drying section 180 and used as a supplement to, or in place of, the drying apparatus 182.

In an exemplary embodiment of the process, a slurry comprising the dihydrate gypsum and water can be fed into a heating tube. The heating tube, having a small cross-section in comparison to a kettle, calciner, autoclave vessel, and the like, provides more contact area between the heated inner surface of the tube and the slurry, thereby heating the slurry faster than the external heating of a vessel or the immersion of a heating element into the slurry. Moreover, the water can be heated beyond its boiling point and turned to steam. The steam pressurizes the heated coil, and further increases the temperature and conversion rate of the dihydrate gypsum. In an exemplary embodiment, the heating tube can be heated to a temperature of about 75° C. to about 180° C. Since the pressure of the slurry inside the tube is directly related to the temperature of the heating tube, the temperature can be raised or lowered to maintain a desired pressure. In an exemplary embodiment, the pressure can be about 0.7 megapascals (MPa) to about 1.4 MPa, specifically about 1.0 MPa to about 1.1 MPa. The heating tube, therefore advantageously provides a continuous high rate conversion of dihydrate gypsum to alpha-hemihydrate gypsum. The high conversion rate provides for a high throughput rate, thereby keeping the process efficient for bulk production of alpha gypsum. Another advantage of this process is no agitation of the slurry is required. The slurry is constantly moving through the length of the heating tube, and therefore, does not settle.

Because the slurry is heated and pressurized more quickly in the process as disclosed herein in comparison to existing processes, the slurry can be continuously fed through the heating tube at a high output rate. In an exemplary embodiment of the process, the average residence time of the slurry in the heating tube can be less than or equal to about 60 minutes, specifically less than or equal to about 30 minutes, more specifically less than or equal to about 10 minutes, even more specifically less than or equal to about 5 minutes. The residence time is directly related to the conversion of the dihydrate gypsum. For the process as disclosed herein, the dihydrate gypsum can be substantially converted to alpha hemihydrate gypsum within the average residence times as listed above. As used herein, the phrase “substantially converted” is generally intended to mean a greater than about 90 percent conversion of dihydrate to alpha-hemihydrate gypsum.

The production (or calcination step as it is sometimes called) of alpha gypsum from dihydrate gypsum is performed by heating the dihydrate gypsum, and generally can be described by the following chemical equation, which shows that heating the dihydrate gypsum yields alpha-hemihydrate gypsum and water vapor:

CaSO₄.2.0H₂O+heat→CaSO₄.0.5H₂O+1.5H₂O

This calcination process step begins as the slurry enters the heating tube and is substantially complete when the slurry exits the heating tube. Upon further loss of water, gypsum anhydrite is produced according to the following chemical equation:

CaSO₄.0.5H₂O+heat→CaSO₄+0.5H₂O

The presence of gypsum anhydrite is generally not desired in the alpha-hemihydrate gypsum process and care must be given to avoid further loss of water.

Dihydrate gypsum (i.e., uncalcined calcium sulfate) is the stable form of gypsum. However, alpha-hemihydrate gypsum (i.e. calcined alpha gypsum) has the desirable property of being chemically reactive with water, and will “set” when mixed with water. This setting reaction is actually a reversal of the above-described chemical reaction performed during the heating step in the heating tube. The setting reaction proceeds according to the following chemical equation, which shows that the gypsum hemihydrate is rehydrated to its dihydrate state:

CaSO₄.0.5H₂O+1.5H₂O→CaSO₄+2.0H₂O+heat

The water requirement for addition to the gypsum is enough to provide about 1.5 moles of water per mole of gypsum for the rehydration reaction plus sufficient water to create a slurry of workable consistency. The actual time required to complete the setting reaction can generally depend upon the type or form of hemihydrate and the type of gypsum used, and can be controlled within certain limits by the use of additives such as retarders, set accelerators, stabilizers, crystal habit modifiers, and the like. In one embodiment, these optional ingredients can be added to the slurry during the manufacture of the alpha gypsum.

Various optional ingredients can be added to the slurry in order for the slurry to achieve desired properties such as improved crystal morphology, improved conversion time, and the like. In one embodiment, optional ingredients can be added to the slurry prior to conversion of the dihydrate gypsum to the alpha-hemihydrate gypsum. In another embodiment, optional ingredients can be added after. One example of optional ingredients includes crystal habit modifiers. Exemplary crystal habit modifiers can include, without limitation, organic acids, such as lower (i.e., one to four carbons) monocarboxylic acids, formic, acetic, propionic, butyric; adipic, ascorbic, benzoic, citric, fumaric, gluconic, isophthalic, maleic, malic, malonic, mandelic, mellitic, oxalic, palmitic, phthalic, pyruvic, salicylic, succinic, sulfanylic, and tartaric acids, salts thereof (such as calcium, sodium, magnesium, and zinc salts), and esters thereof. A crystal habit modifier can be added to the slurry in a concentration of about 0.001% by weight to about 1% by weight, specifically about 0.01% by weight to about 0.5% by weight, more specifically 0.2% by weight, based on the total weight of the mixture.

Exemplary crystallization catalysts can include, without limitation, water-soluble inorganic salts, such as aluminum sulfate, ammonium chloride, ammonium nitrate, calcium chloride, calcium nitrate, magnesium chloride, magnesium nitrate, magnesium sulfate, sodium chloride, sodium nitrate, potassium chloride, and zinc chloride. Other known crystallization catalysts can include amide-derivatives of higher fatty acids, sulfate esters or higher alcohols; surface active agents having a sulfonic acid group as the hydrophilic atomic group; water-soluble proteins such as keratin, casein, glues, and the like; and salts of lower aliphatic polycarboxylic acids, such as succinic acid, citric acid, and the like. Specifically, crystallization catalysts can include water-soluble inorganic salts, more specifically calcium chloride. The use of sodium chloride can be avoided if the alpha-hemihydrate gypsum will be used in applications requiring high strength gypsum.

A crystallization catalyst can be used in a concentration of at least about 2 molar. Below a concentration of about 2 molar, the catalyst can become less effective on the rate of production of alpha-hemihydrate gypsum. The range of catalyst concentration in the process disclosed herein does not have an upper limitation, but for practical purposes the solubility limit of a salt in the aqueous mixture can be a maximum concentration, above which there are no benefits for the additional amount of catalyst added. When using calcium chloride as a crystallization catalyst, the concentration can be about 2.5 molar to about 3.5 molar, specifically about 3 molar.

The optional ingredients, such as the crystallization catalyst, can be combined with the water prior to addition of the dihydrate gypsum. However, other orders of addition are possible, such as adding the crystallization catalyst last, or adding a crystallization catalyst, water, and dihydrate gypsum together at once.

As described herein, reference has been made to the production of alpha-hemihydrate gypsum from dihydrate gypsum. While this is an exemplary process, other forms of gypsum can be used to form the alpha-hemihydrate gypsum. The gypsum used can be other forms of calcium sulfate such as calcium sulfate beta-hemihydrate, and soluble calcium sulfate anhydrite. Both the calcium sulfate beta-hemihydrate and anhydrite forms will first undergo hydration to dihydrate gypsum before conversion to alpha-hemihydrate gypsum. Thus, dihydrate gypsum is a preferred starting material for faster production of alpha-hemihydrate gypsum, and is also the most common form of calcium sulfate available from sources such as land plaster and in flue gas desulfurized gypsum.

There is no minimum concentration of the dihydrate gypsum in the slurry for use in the process, but, for practical purposes, a minimum concentration of about 1% by weight, based on the weight of the water, can begin to produce sufficient alpha-hemihydrate gypsum to justify the energy input costs. Greater than about 50% by weight, a slurry of water, the dihydrate gypsum, and any optional ingredients, can begin to thicken to the extent that the access of crystallization catalyst and/or crystal habit modifiers (if used) to the dihydrate gypsum is restricted, and the required time for full conversion to alpha-hemihydrate gypsum is lengthened. In addition, above about 50% dihydrate gypsum by weight, the crystal morphology of the alpha-hemihydrate gypsum can be affected. An exemplary concentration of dihydrate gypsum can be in the range of about 5% by weight to about 40% by weight, more specifically about 10% by weight to about 25% by weight, based on the weight of the water. The dihydrate gypsum can be added to a hot or a cold solution of water, optional crystallization accelerator and optional additional ingredients such as a crystal habit modifier. In another embodiment, all ingredients can be added to a mixer at once.

The process as described herein is able to quickly and efficiently convert the dihydrate gypsum by heating the gypsum faster. The heating tube used in the process advantageously provides a continuous, high rate conversion of dihydrate gypsum to alpha-hemihydrate gypsum. The high conversion rate provides for a high throughput rate, thereby keeping the process efficient for bulk production of alpha gypsum. Moreover, no agitation of the slurry is required because the slurry continuously circulates through the heating tubes, thereby never having a chance to settle out.

The invention is further illustrated by the following non-limiting examples.

### EXAMPLES

Dihydrate gypsum was converted to alpha-hemihydrate gypsum with a heating tube made of schedule 80 steel pipe. The steel pipe had an inner diameter of 0.5 inches (1.27 cm) and a length of 100 feet (30.5 m). The steel pipe was housed in an oil-fired steam generator. Water was pumped and heated in the heating tube until a steam pressure of 165 pounds per square inch (psi) was reached. A mixture of 2 pounds dihydrate gypsum and 6.7 pounds water was introduced to the inlet of a Moyno pump and was pumped into the heating tube. It took two minutes from the time the pump was started feeding the 23% dihydrate gypsum-77% water slurry mixture in the heating tube until the converted alpha-hemihydrate gypsum slurry exited the condenser.

Ten different samples were run through the heating tube and converted to hemihydrate gypsum. The feed rate of the slurry through the steam generator and condenser varied from 0.45 gallons per minute (gpm) to 0.54 gpm. The dihydrate gypsum material used for the samples was land plaster from the Georgia Pacific® Vegas plant. 1.0 gram (gm) of succinic acid was added to each sample as a retarder—to aid in preventing the gypsum from setting. The succinic acid used was S1041-45, Lab Grade, produced by Chem Products®. The temperature of the slurry was maintained at 350 degrees Fahrenheit (° F.) and the steam pressure in the heating tube was between about 130-175 psi depending on the sample.

The combined water percentage, testing consistency (TC) and pouring consistency (PC) were measured to determine quality of the alpha-hemihydrate gypsum produced in each sample. The combined water percentage analysis determines the percent of chemically combined water contained in the gypsum sample and is used to calculate the purity of the gypsum. In other words, this is not the free water that can be dried through evaporation. The combined water percentage is measured in accordance with ASTM C471M-01 Section 8 (approved Dec. 1, 2006). Dihydrate gypsum generally has a combined water percentage of about 18 to 20 percent by weight. Three quarters of the combined water is removed through the conversion (i.e., calcination) process. After conversion to alpha-hemihydrate gypsum, the combined water percentage should be about 6 percent by weight.

TC is a measurement of the amount of water (in milliliters (mL)) it takes per 100 gm of alpha-hemihydrate gypsum to make a stiff mixture that can be used to measure set time. Alpha gypsum should have a TC of about 30 mL, while beta gypsum has a TC of around 50 mL. The “setting time” for the gypsum can then be determined in accordance with ASTM C472-99 Section 10 (approved May 1, 2004), also known as the Vicat Set Time Test.

Finally, PC is a measurement of the amount of water (in mL) per 100 gm of calcined hemihydrate to make a 6 inch diameter spread when poured onto a glass plate. Alpha gypsum should use about 48 mL of water to make the 6 inch spread.

The process conditions and results of the alpha gypsum quality measurements are reproduced in Table 1 below:

TABLE 1

| | Feed | Steam | | | | |
|---|---|---|---|---|---|---|
| | Rate | Pressure | | Combined | TC | PC |
| Sample | gpm | psi | Temperature F. | Water % | mL | mL |
| 1 | 0.45 | 150-160 | 350 | 6.2% | 30 | 52 |
| 2 | 0.45 | 150-160 | 350 | 6.5% | 32 | 56 |
| 3 | 0.54 | 150-160 | 350 | 6.0% | 32 | 56 |
| 4 | 0.45 | 150-160 | 350 | 6.8% | 32 | 53 |
| 5 | 0.45 | 140-150 | 350 | 6.2% | 31 | 48 |
| 6 | 0.45 | 140-150 | 350 | 6.4% | 31 | 49 |
| 7 | 0.49 | 150 | 350 | 6.2% | 30 | 48 |
| 8 | 0.49 | 150 | 350 | 6.0% | 31 | 48 |
| 9 | 0.45 | 150 | 350 | 6.0% | 30 | 48 |
| 10 | 0.45 | 165-175 | 350 | 6.2% | 32 | 52 |

All of samples 1-10 had a combined water percentage between 6.0 and 6.8%, indicating that the dihydrate gypsum was calcined to alpha-hemihydrate gypsum. Likewise, the testing consistency for each sample is indicative of alpha gypsum. None of the samples approach the 50 mL TC of beta gypsum. Moreover, the PC of the calcined gypsum is also indicative of good conversion to alpha-hemihydrate gypsum as a 6 inch spread required 48 to 56 mL of water for samples 1-10. From the table, it appears the additional retarder had no noticeable effect on the combined water percentage, TC, or PC of the alpha-hemihydrate samples. Likewise, the variance in feedrate, while moving the slurry more quickly through the heating tube and therefore converting at a faster rate, did not change the quality of the gypsum as the TC and PC values of Samples 3, 7, and 9 illustrate.

Ranges disclosed herein are inclusive and combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by context, (e.g., includes the degree of error associated with measurement of the particular quantity). The suffix “(s)” as used herein is intended to include both the singular and the plural of the term that it modifies, thereby including one or more of that term. Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While the invention has been described with reference to exemplary embodiments, it will be understood by those skilled in the art that various changes may be made and equivalent elements may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying this invention, but that the invention will include all embodiments falling within the scope of the appended claims. Moreover, the use of the terms, first, second, etc. are used to distinguish one element from another. Furthermore, the use of the terms a, an, etc. do not denote a limitation of quantity, but rather denote the presence of at least one of the referenced items.

What is claimed is:

1. A process for producing alpha-hemihydrate gypsum from dihydrate gypsum, comprising:
feeding a slurry comprising the dihydrate gypsum and water into a heating tube;
heating the heating tube at a temperature effective to generate steam and pressure from the water, wherein the steam and pressure are effective to convert the dihydrate gypsum to the alpha-hemihydrate gypsum; and
withdrawing the alpha-hemihydrate gypsum from the heating tube.

2. The process of claim 1, wherein the temperature is about 75 degrees Celsius to about 180 degrees Celsius.

3. The process of claim 1, wherein the pressure is about 0.7 megapascals to about 1.4 megapascals.

4. The process of claim 1, further comprising mixing the dihydrate gypsum and the water to form the slurry.

5. The process of claim 4, wherein the mixing further comprises adding a crystallization catalyst, a crystal habit modifier, a retarder, or a combination comprising at least one of the foregoing to the slurry.

6. The process of claim 1, wherein the heating tube has a circular coil shape.

7. The process of claim 1, wherein the feeding is effective to provide an average residence time of less than or equal to about 10 minutes.

8. The process of claim 1, wherein heating the heating tube comprises contacting an outer surface of the heating tube with a heat source, wherein the heat source is a selected one of an oil burner and a gas burner.

9. A process for producing alpha-hemihydrate gypsum from dihydrate gypsum, comprising:
mixing the dihydrate gypsum with water to form a slurry;
pumping the slurry into a heating tube at a flowrate effective for the slurry to have an average residence time in the heating tube of less than or equal to about 10 minutes;
heating the heating tube at a temperature effective to generate steam and pressure from the water, wherein the steam and pressure are effective to substantially convert the dihydrate gypsum to the alpha-hemihydrate gypsum; and
withdrawing the alpha-hemihydrate gypsum and steam from the heating tube;
cooling the alpha-hemihydrate gypsum and steam to a temperature effective to condense the steam; and
removing the water from the alpha-hemihydrate gypsum.

10. The process of claim 9, wherein the temperature is about 75 degrees Celsius to about 180 degrees Celsius.

11. The process of claim 9, wherein the pressure is about 0.7 megapascals to about 1.4 megapascals.

12. The process of claim 9, wherein the heating tube has a circular coil shape.

13. The process of claim 9, wherein the cooling comprises feeding the alpha-hemihydrate gypsum and the steam into a steam condenser comprising a cooling water stream.

14. The process of claim 13, further comprising recycling the cooling water stream to combine with the water from the mixing step subsequent to condensing the steam.

15. The process of claim 9, wherein the removing the water comprises feeding the alpha-hemihydrate gypsum onto a suction belt comprising a vacuum suction unit disposed below the suction belt, wherein the suction belt is effective to remove the water from the alpha-hemihydrate gypsum.

16. The process of claim 15, further comprising recycling the water from the vacuum suction unit to combine with the water from the mixing step subsequent to removing the water from the alpha-hemihydrate gypsum.

17. The process of claim 9, wherein the heating comprises providing heat with a heat source, wherein the heat conductively heats an outer surface of the heating tube.

18. The process of claim 17, further comprising recycling the heat to a drying unit effective to dry the alpha-hemihydrate gypsum subsequent to removing the water, wherein the heat is recycled subsequent to heating the heating tube.

19. The process of claim 10, wherein the mixing further comprises adding a crystallization catalyst, a crystal habit modifier, a retarder, or a combination comprising at least one of the foregoing to the slurry.

20. A system for converting producing alpha-hemihydrate gypsum from dihydrate gypsum, comprising:
a mixer configured to mix a first amount of dihydrate gypsum with a second amount of water to form a slurry;
a heating tube in fluid communication with the mixer, wherein the heating tube has a coiled shape with an inlet and an outlet, wherein the inlet is configured to receive the slurry from the mixer;
a heat source in operative communication with the heating tube, wherein the heat source is configured to heat the heating tube to a temperature effective to generate steam and pressure from the water, wherein the steam and pressure are effective to substantially convert the dihydrate gypsum to the alpha-hemihydrate gypsum;
a steam condenser in fluid communication with the outlet of the heating tube, wherein the steam condenser comprises a cooling water stream and is configured to cool the alpha-hemihydrate gypsum and steam to a temperature effective to condense the steam;
a water removal unit in fluid communication with the steam condenser, wherein the water removal unit comprises a suction belt and a vacuum suction unit disposed below the suction belt, wherein the water removal unit is configured to remove the water from the alpha-hemihydrate gypsum; and
a drying section in fluid communication with the water removal unit, wherein the drying section comprises a drying apparatus configured to dry the alpha-hemihydrate gypsum.
